(19) United States
(12) Patent Application Publication
(10) Pub. No.: US 2014/0326844 A1
(43) Pub. Date: Nov. 6, 2014

(54) Ceiling Hook

(71) Applicant: Scott Sullivan, San Francisco, CA (US)

(72) Inventor: Scott Sullivan, San Francisco, CA (US)

(21) Appl. No.: 14/269,144

(22) Filed: May 4, 2014

Related U.S. Application Data
(60) Provisional application No. 61/819,831, filed on May 6, 2013.

(51) Int. Cl. F16B 45/02

(52) U.S. Cl. CPC F16B 45/02
USPC 248/339

(57) ABSTRACT

A ceiling hook includes a base and a hook. The hook is pivotally connected to the base. The base includes a recess that is sized and shaped to laterally receive the head of a separate screw. The screw is secured to a ceiling structure so that the screw head resides a predetermined distance from the ceiling surface. The hook is pivotal with respect to the base between an open orientation wherein the recess is open allowing passage of a screw head and a closed orientation wherein the recess is closed, thereby capturing any inserted screw head. The hook is designed to support a load and is biased to the closed orientation in response to the downward force generated by a supported load.

### CROSS-REFERENCE TO RELATED APPLICATION

This application claims the benefit of U.S. Provisional Application No. 61/819,831, filed May 6, 2013, entitled “Ceiling Hook.”

### BACKGROUND OF THE INVENTION

1) Field of the Invention

The present invention generally relates to ceiling hooks of the type used to suspend items from the ceiling of a dwelling or building, and more particularly, to such ceiling hooks that are easy to install and can swivel about a vertical axis.

2) Discussion of Related Art

Ceiling hooks (sometimes called “swag hooks”) are well known and used regularly to suspend any of a variety items from a ceiling or overhead beam. Such items include plants, baskets, decorative artwork and pendent lighting fixtures. There are several types of ceiling hooks commercially available. One type includes a separate base that is first secured to the ceiling structure using an appropriate fastener. The base thereafter receives a hook structure in such a manner that allows the hook to freely swivel about the secured base. Another type of conventional ceiling hook includes an integral screw which allows the user to secure the hook into a wooden ceiling structure quickly and easily, but in a rigid and non-swivel manner. Although this type of ceiling hook is relatively easy to manufacture and install, it does have the disadvantages of requiring access to a wooden ceiling structure and can easily unscrew accidentally in response to rotation of the hanging load. For example, if this type of hook is used to hold up a planter and the planter rotates, the hook can easily unscrew from the ceiling, causing the planter to fall and possibly cause damage and injury.

Yet another type of conventional ceiling hook includes a threaded bore that is adapted to receive one end of a threaded stud. The other end of the stud can either include a machine thread for engaging a toggle for sheetrock installations, or a course “wood” thread for engaging a wood ceiling structure. The installer must assemble the hook depending on the type of material the hook will be installed.

### OBJECTS OF THE INVENTION

It is an object of the invention to provide a new and improved swivel ceiling hook.

It is another object of the invention to provide a swivel ceiling hook that can be easily attached to a ceiling, is firmly secured after attachment, and only can be removed by a lifting force and a subsequently applied rotational force so that the connection between the ceiling and the hook cannot be dislodged accidentally.

Other objects of the invention in part will be obvious and in part will be pointed out hereinafter.

### SUMMARY OF THE INVENTION

A ceiling hook includes a base and a hook. The hook is pivotally connected to the base. The base includes a recess that is sized and shaped to laterally receive the head of a separate screw. The screw is secured to a ceiling structure so that the screw head resides a predetermined distance from the ceiling surface. The hook is pivotal with respect to the base between an open orientation wherein the recess is open allowing passage of a screw head and a closed orientation wherein the recess is closed, thereby capturing any inserted screw head. The hook is designed to support a load and is biased to the closed orientation in response to the downward force generated by a supported load.

### BRIEF DESCRIPTION OF THE DRAWINGS

FIG. 1 is a perspective exploded view of the hook assembly, according to the present invention, including a base, a hook, and a hinge pin (a ceiling screw is also shown);

FIG. 2 is an exploded elevation side view of the hook assembly, according to the present invention, showing the hook separated from the base;

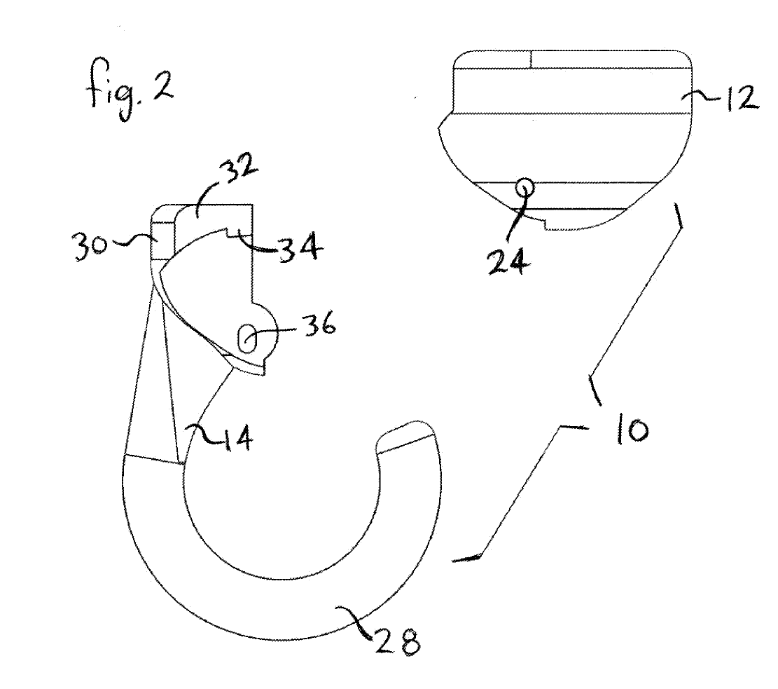

FIG. 3 is an elevation side view of the hook assembly, according to the present invention, showing the hook in an up and open position for receiving the head portion of the ceiling screw;

FIG. 4 is a sectional view of the hook assembly of FIG. 3 showing details of a shaped cavity within the body which is sized and shaped to receive the head of the screw, according to the present invention;

FIG. 5 is a sectional view similar to FIG. 4, but this figure shows the head of the ceiling screw located within the shaped cavity of the body, according to the present invention;

FIG. 6 is a perspective view of the hook assembly of FIG. 5, according to the present invention, showing the head of the ceiling screw located within the shaped cavity of the body;

FIG. 7 is an elevation side view of the hook assembly, according to the present invention, showing the hook in an up and open position for receiving the head portion of the ceiling screw and showing the head of the screw fully inserted in the base;

FIG. 8 is a sectional view of the hook assembly of FIG. 7 showing details of a shaped cavity within the body which is sized and shaped to receive the head of the screw, and showing the head of the screw fully inserted within the base;

FIG. 9 is a perspective view of the hook assembly of FIG. 7, according to the present invention, showing the head of the ceiling screw fully inserted within the shaped cavity of the body;

FIG. 10 is an elevation side view of the hook assembly, according to the present invention, showing the hook in a down and closed position for retaining the head portion of the ceiling screw and showing the head of the screw fully inserted in the base;

FIG. 11 is a sectional view of the hook assembly of FIG. 10, according to the present invention, showing the hook in a down and closed position for retaining the head portion of the ceiling screw and showing the head of the screw fully inserted in the base, the hook is not locked;

FIG. 12 is an elevation side view of the hook assembly, according to the present invention, showing the hook in a down and closed position for retaining the head portion of the ceiling screw and showing the head of the screw fully inserted in the base and showing the hook in a locked position which prevents the hook from pivoting to the up and open position;

FIG. 13 is a sectional view of the hook assembly of FIG. 12, according to the present invention, showing the hook in a down and closed position for retaining the head portion of the ceiling screw and showing the head of the screw fully inserted in the base, and showing the hook locked with locking tabs of the hook seated into locking recesses of the base;

FIG. 14 is a perspective view of the hook assembly of FIG. 12, according to the present invention;

FIG. 15 is a sectional view of the hook assembly of FIG. 14, taken along the lines 15-15 of FIG. 14, showing details of the locking tabs of the hook seated within the locking recesses of the body, which locks the hook in the down position and holds the body firmly, yet pivotally to the ceiling screw;

FIG. 16 is a perspective view of the hook assembly showing the ceiling screw captured within the body and the hook located in the down and closed position, the hook is shown unlocked with respect to the body so it can still pivot, according to the invention;

FIG. 17 is a sectional view of the hook assembly of FIG. 16, taken along the lines 17-17 of FIG. 16, showing details of the locking tabs of the hook being disengaged with the locking recesses of the body, so that hook may still pivot about the pin from the down position to the up position, according to the invention; and

FIG. 18 is a sectional side view of the hook assembly of FIG. 17, showing details of the locking tabs of the hook being disengaged with the locking recesses of the body, so that hook may still pivot about the pin from the down position to the up position, according to the invention.

### DETAILED DESCRIPTION OF THE PREFERRED EMBODIMENTS

Briefly described, the preferred embodiment of the present ceiling hook includes a strong metal hook that is pivotally connected to a metal body by a pin. The body includes a cavity that is sized and shaped to receive the head of a screw that is secured to a ceiling. The hook can pivot between an hook-up position wherein the cavity is open and free to receive a screw head and a hook-down position wherein the cavity becomes closed and any captured screw head will remain held within the body. The hook is preferably vertically displaceable a small amount between an up and unlocked position and a down and lockable position. When the hook is locked (i.e., when it is in the down position), the hook will be unable to accidentally pivot to the hook-up position so that the captured screw head cannot accidentally separate from the body. This is a safety measure to prevent a hung item from accidentally falling during use. Finally, the body is free to rotate about the screw head during use.

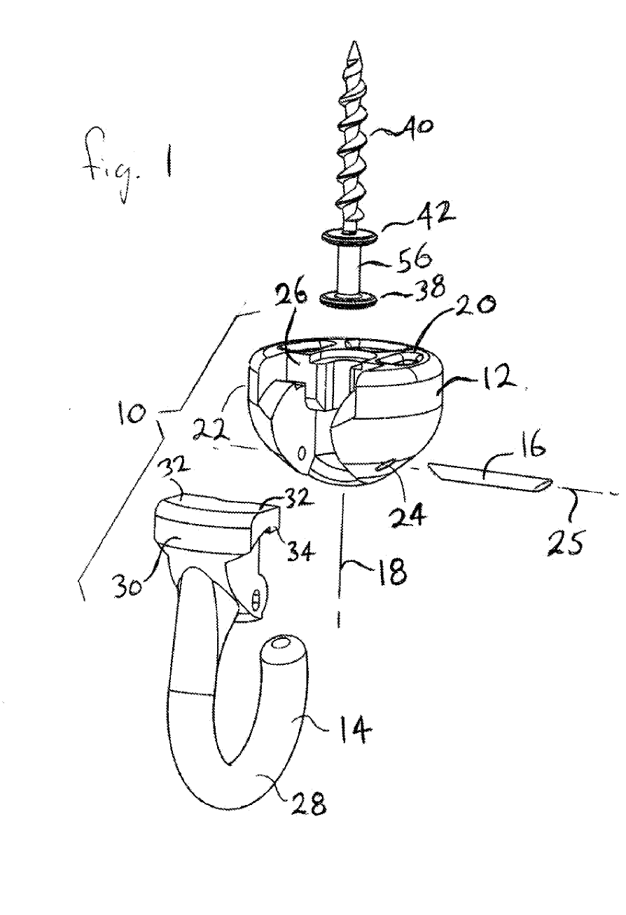

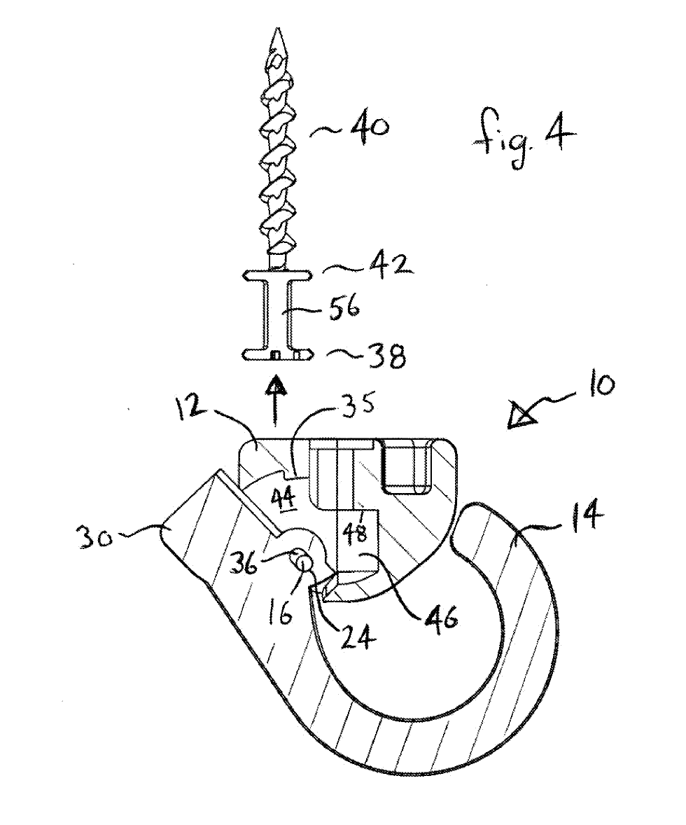

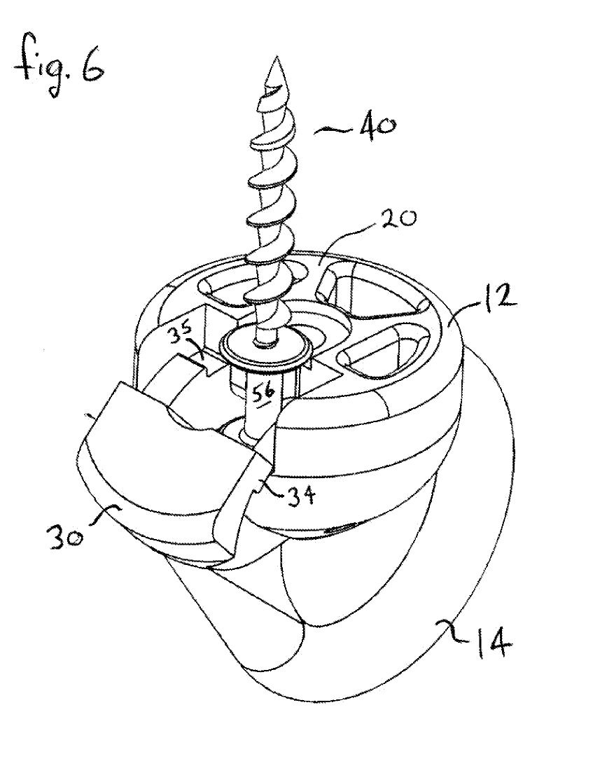

Referring to FIG. 1, a ceiling hook 10, according to the present invention is shown, including hook 14 which is pivotally connected to body 12 by cylindrical pin 16. Body 12 includes a central vertical axis 18, a top 20 and a side 22. Side 22 has a pin bore 24 located along a pivoting axis 25 that is sized and shaped to snugly receive cylindrical pin 16 (preferably a press-fit to body 12 so that it will not slip free). Body 12 further includes a shaped cavity 26 that is accessible from both top 20 and side 22, as shown in FIGS. 1, 4, 5, and 6.

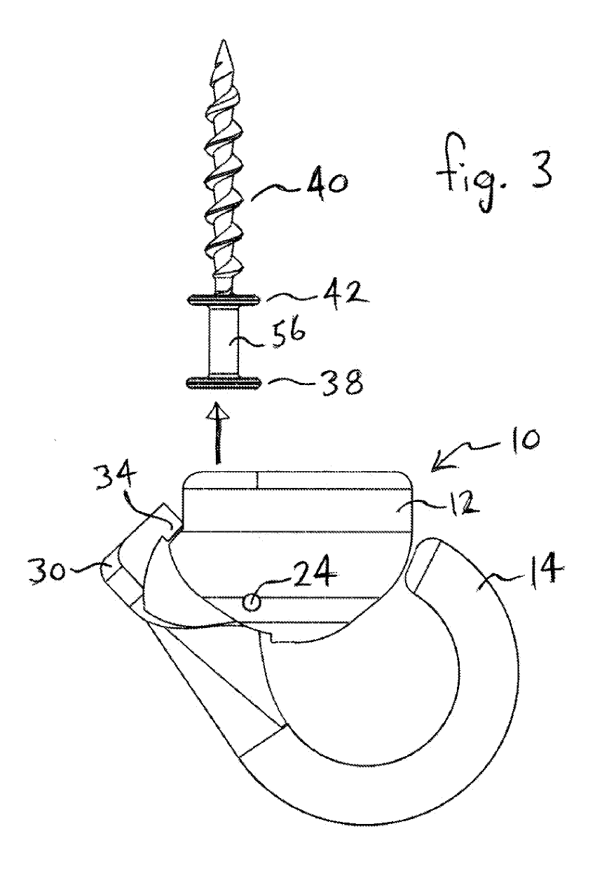

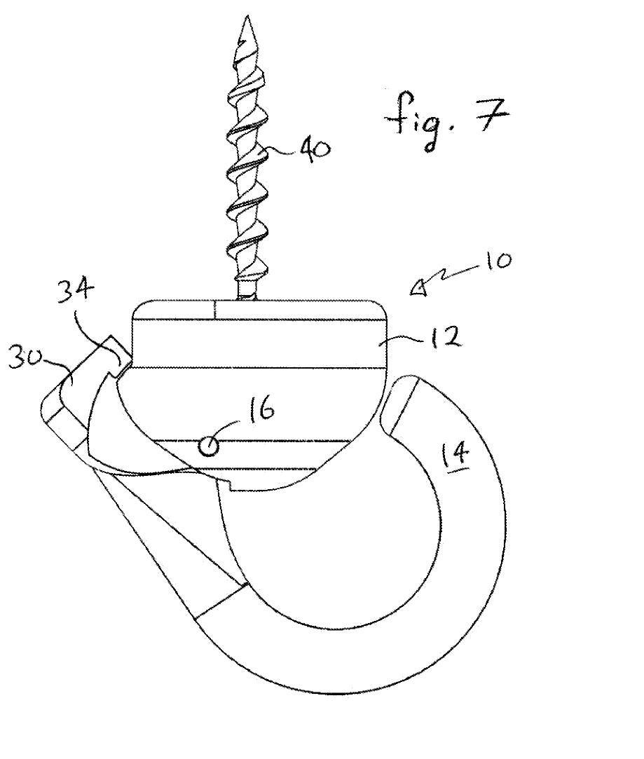

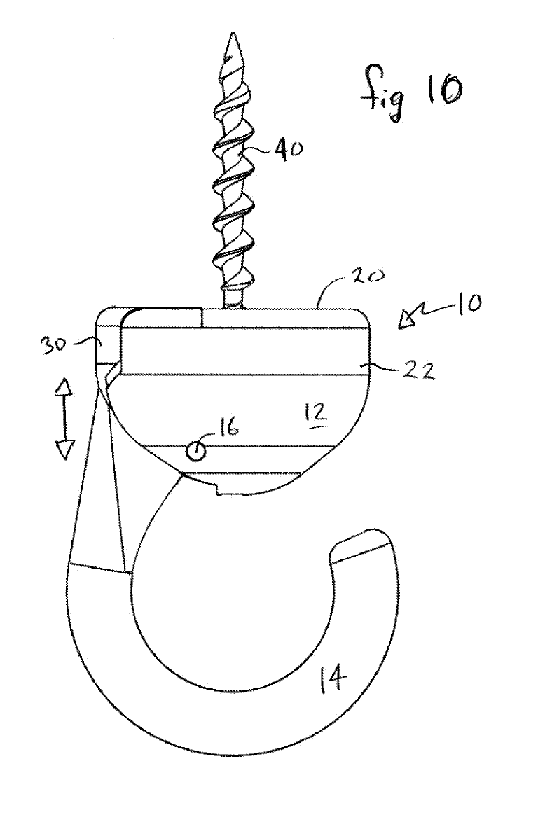

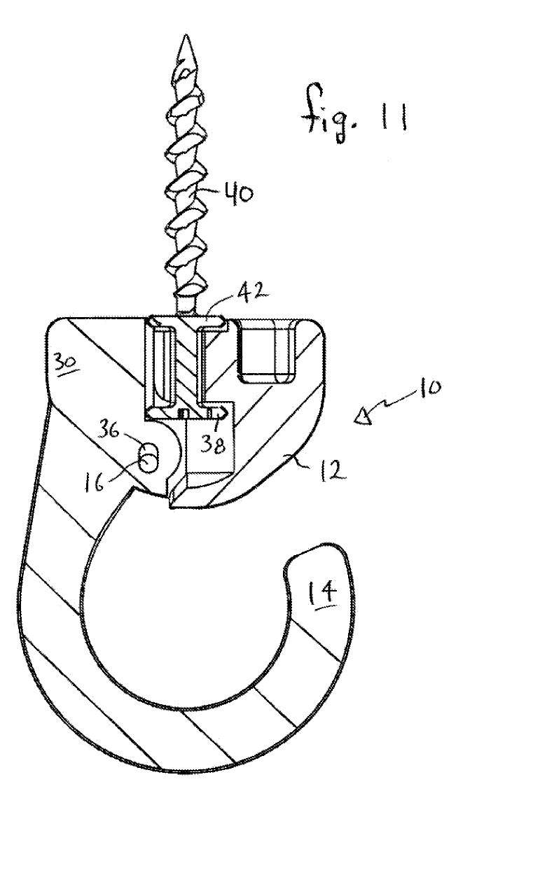

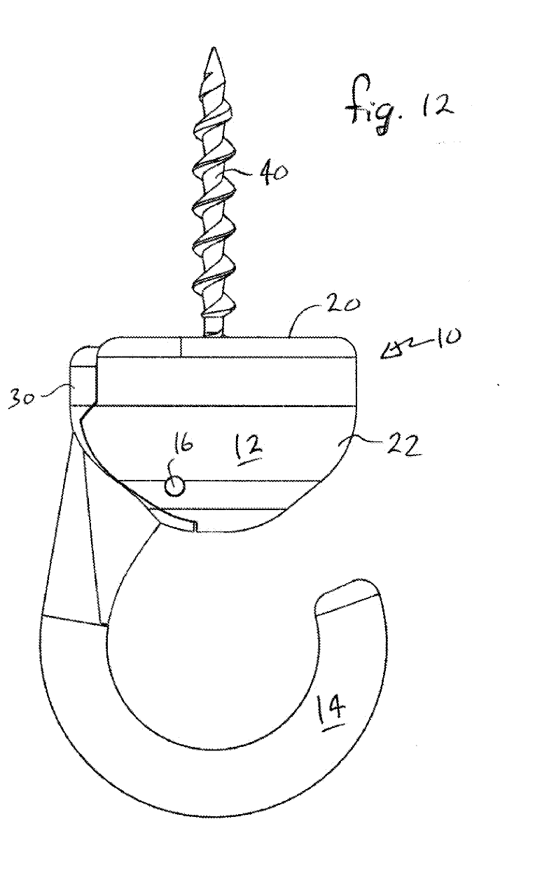

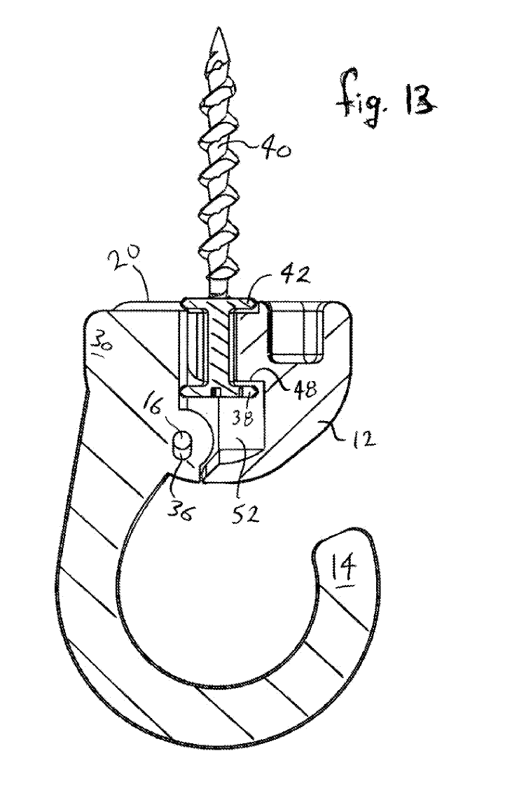

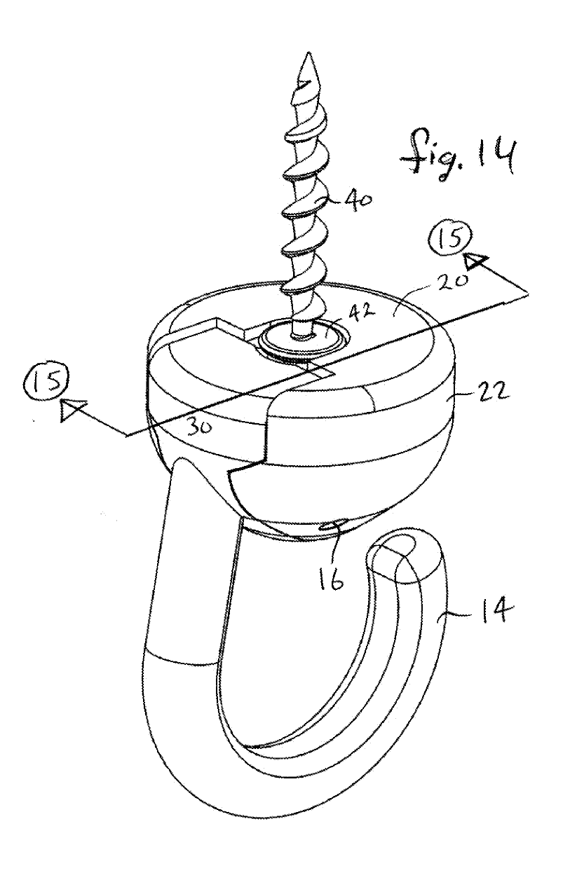

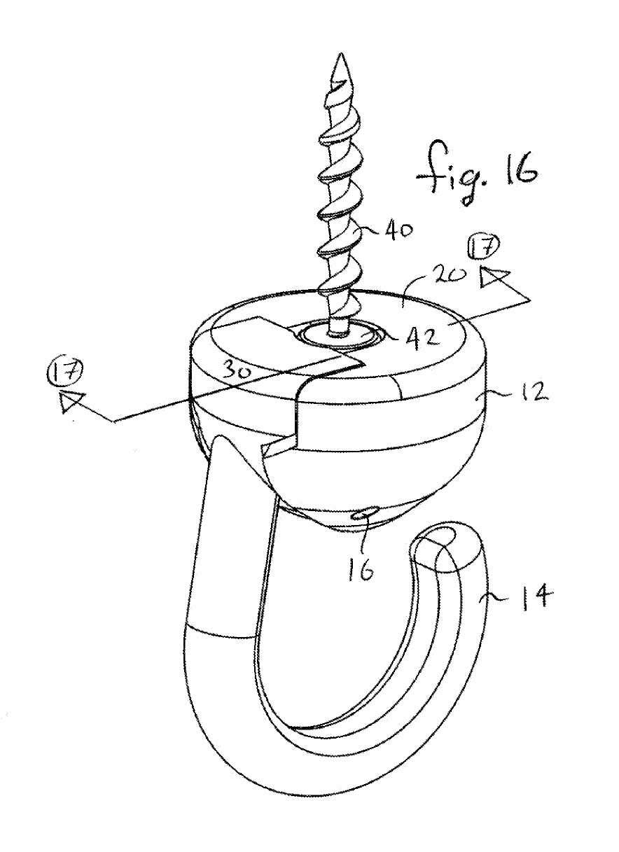

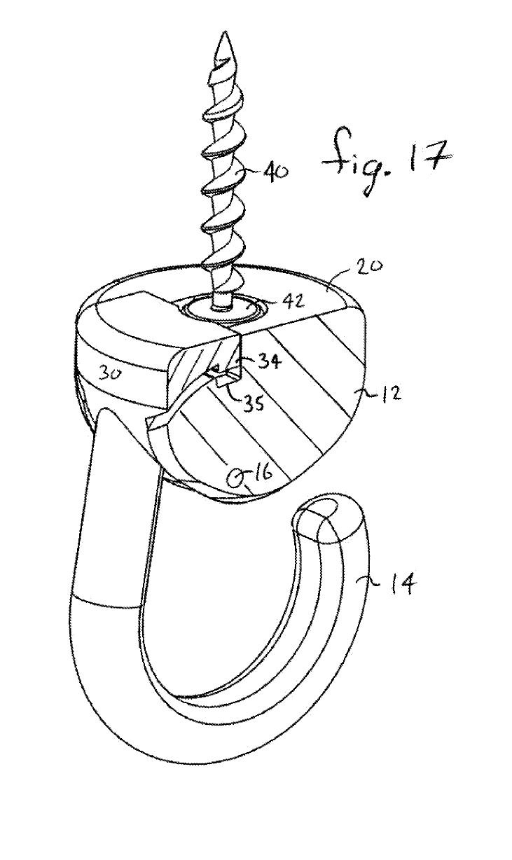

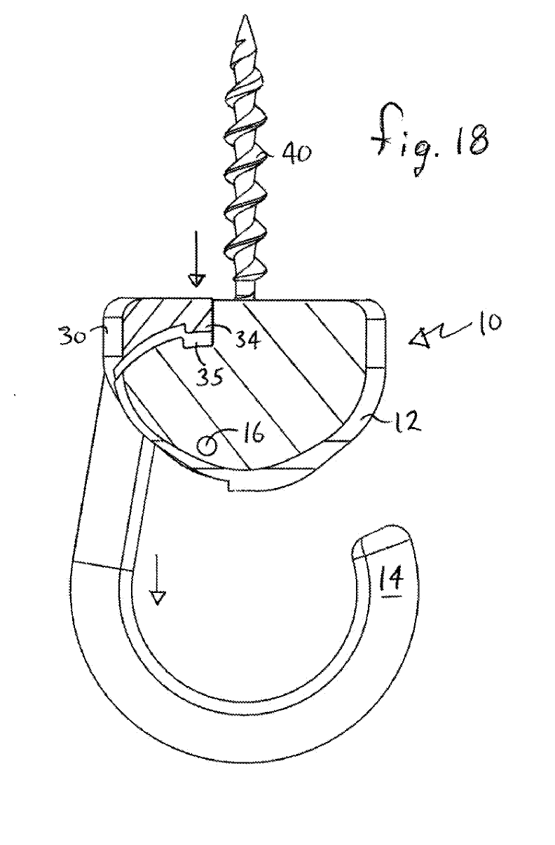

Hook 14 is preferably made from a strong suitable metal alloy, as detailed below and includes a U-shaped hook portion 28 that is located in and defines a hook plane and an upper connection end 30. According to the preferred embodiment of this invention, upper connection end 30 preferably includes two opposing support sections 32 and two locking tabs 34, one of each being located on each side of the hook plane, as shown in FIGS. 1, 6, and 9. Upper connection end 30 further includes an axle slot 36 that has an elongated rounded-rectilinear cross-sectional shape (a shape that is similar to a rectangle with rounded ends) and is sized to slidingly receive pin 16 in such a manner that allows pin to move within slot 36 from one end of the slot to the other in a direction that is generally parallel to vertical axis 18, as described below. Hook portion 28 is pivotally connected to body 12 by pin 16 passing through pin bore 24 of body 12 and axle slot 36 of hook 28. As mentioned above, pin 16 preferably forms a tight tolerance fit in pin bore 24 and a loose fit within axle slot 36. Once assembled, as described in greater detail below, axle slot 36 allows hook 28 to be displaced a small distance along a path that is parallel to central vertical axis 18, between a locked position, wherein hook is at a lowest position and locked with respect to body 12 (as shown in FIGS. 12, 13, 14, and 15), and a released (un-locked) position wherein hook 28 is at an uppermost position and unlocked with respect to body 12 (as shown in FIGS. 10, 11, 16, 17, and 18). Hook 14 may also pivot about pin 16, but only when it is located at the upper and unlocked position, as shown in FIGS. 10, 11, 16, 17 and 18. When unlocked, hook 14 may pivot between a hook-down position (shown in FIGS. 10, 11, 16, 17, and 18), and a hook-up position (shown in FIGS. 3 through 9).

Hook 14 is pivotally secured to body 12 by pin 16 passing through pin bore 24 of body 12 and axle slot 36 of hook 14. As introduced above, hook 14 can pivot about pin 16 in a somewhat loose fit as provided by the elongated sectionally-shaped axle slot 36 of hook 14. This allows hook 14 to be moveable up and down a small amount (controlled by the sectional length of slot 36) when hook 28 is located in the down position, as shown in FIGS. 10, 11, 16, 17, and 18. This small movement allows locking tabs 34 to engage and disengage with locking recesses 35 that are integrally formed within shaped cavity 26 of body 12, as shown in FIGS. 1, 4, 6, 8, 9, 15, 17, and 18.

Ceiling hook 10, according to the present invention, is designed to be secured to the head portion 38 of a screw 40 that has been secured to a ceiling or some other suitable overhead structure. Screw 40 may include wood threads, such as what is shown in the figures, so that it can be secured directly to a wood beam or an internal wood structure, such as a joist. Alternatively, screw 40 may be secured to drywall (also called sheetrock) if the hanging location happens to be located between two ceiling joists and no wood structure is immediately available for securement. In such instance, an expanding toggle or other appropriate drywall fastener is used to secure the screw to the drywall. Toggle screws typically include finer machine-type threads. Regardless of how screw 40 is secured to the ceiling or the type of screw used, end head 38 will be positioned a certain distance down from the ceiling surface. A preferred screw 40 for use with the present invention includes two axial heads, an end head 38 and an additional intermediate head 42. This type of screw is commercially available from Hangman Products of Woodlawn Hills, Calif. When this double head screw is used and tightened into a ceiling surface, intermediate head 42 will firmly contact the ceiling surface first and this contact will halt further screw advancement. The end result is that intermediate head 42 will always space end head 38 a predetermined and correct distance from the ceiling surface. If conventional single-head screws are used, the user will have to tighten the screw into the ceiling surface so that the single end head 38 will eventually reside the predetermined and correct distance from the ceiling surface.

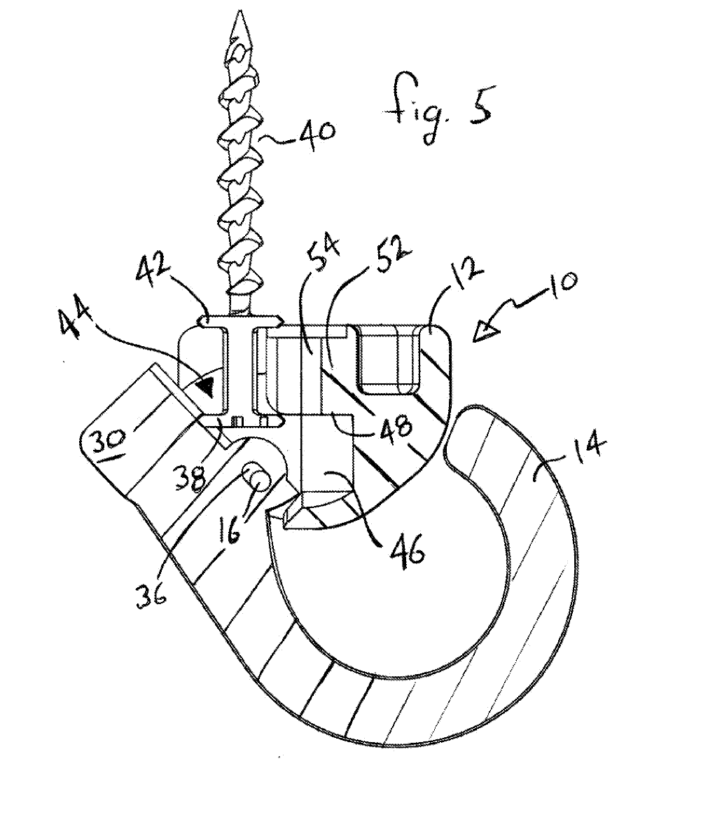

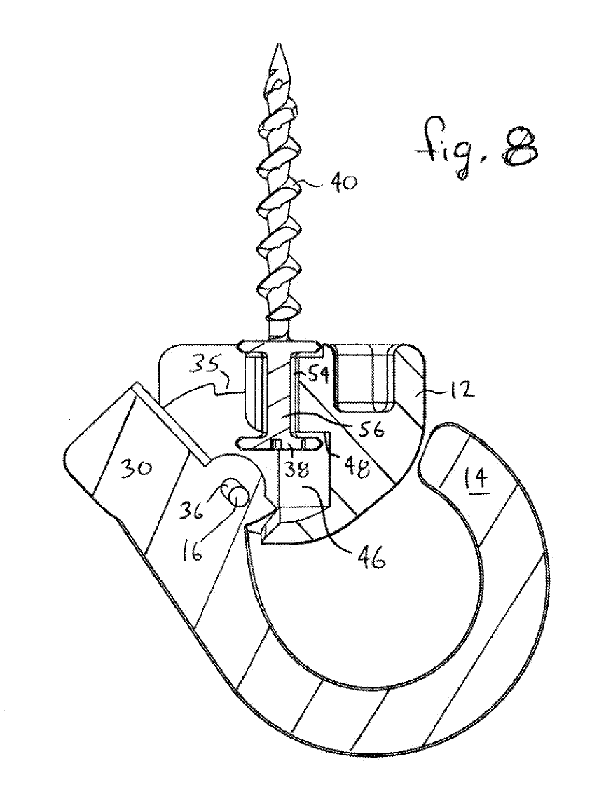

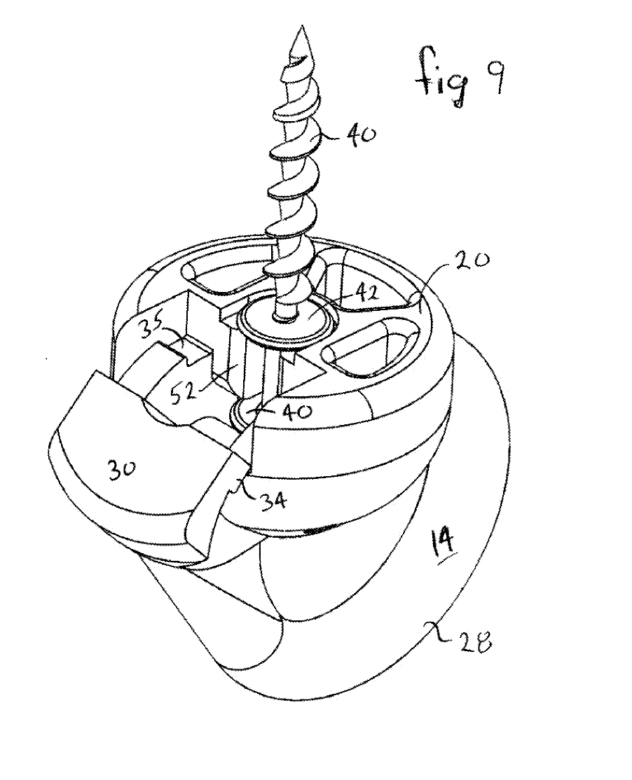

Referring to FIGS. 1, 4, 5, 8,9, 11 and 13, shaped cavity 26 includes an entryway 44 and a seating zone 46. Entryway 44 is sized and shaped to accommodate passage of end head 38 of screw 40 (include the shaft 56 of screw 40) when hook 10 is being secured to or detached from screw 40, as shown in FIGS. 5, 6, 8, and 9. Seating zone 46 is preferably located in line with vertical axis 18 and defines a head-seating surface 48, which is located at a lower end 50 of a support block 52. Support block 52 is integrally formed within shaped cavity 26 of body 12 and further includes an integrally formed vertical channel 54 that is located about vertical axis 18. This vertical channel is sized to accommodate shaft 56 of screw 40 when screw 40 is inserted into shaped cavity 26. Seating zone 48 is sized and shaped to receive end head 38 of screw 40 when inserted therein, as shown in FIGS. 8 and 9.

In use, an installer starts off by securing a screw 40 into a ceiling joist or appropriate toggle into sheetrock, at a desired mounting location. If the installer is using a preferred screw 40 that includes two axial heads, as described above, then the screw 40 just has to be advanced into the ceiling or toggle until intermediate head 42 contacts the ceiling surface (or an interposed washer, if one is being used, not shown). This will automatically position end head 38 the predetermined distance from the ceiling surface, as required in this invention. The preferred distance is approximately equal to the distance between top surface 20 of body 12 and head-seating surface 48. This distance is such that top surface 20 of body 12 will reside within about 2 mm from the ceiling surface (or washer, if used) when installed. If a conventional, single head screw is used, then the user will tighten the screw into the ceiling or toggle until the predetermined distance is reached. Once the screw is installed, the installer first displaces hook 14 towards body 12 along axis 18 so that locking tabs 34 lift out of locking recesses 35 of body 12 (if it is locked). The user can then pivot the now unlocked hook 14 (as shown in FIGS. 10, 11, 16, 17 and 18) about pin 16 from the hook-down position (shown in FIG. 10) to the hook-up position (shown in FIG. 3). This opens up entryway 44 so that end head 38 of ceiling-installed screw 40 can be received by entryway 44 and shaped cavity 26 (as shown in FIG. 5) and, once the end head is inserted, body 12 is moved sideways along the ceiling surface so that the inserted end head 38 can be positioned into seating zone 46 of body 12, as shown in FIGS. 8 and 9. When in this position, end head 38 will contact head-seating surface 48 and shaft 56 of screw 40 will snugly seat within vertical channel 54.

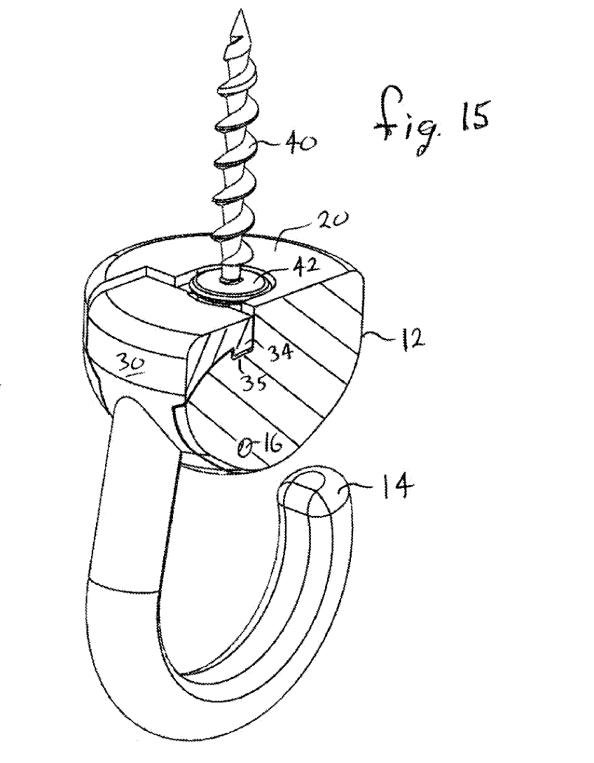

Once end head 38 is seated in seating zone 46, the installer simply pivots hook 14 about pin 16 to the hook-down position (shown in FIGS. 10, 11, 16, 17 and 18) so that entryway 44 becomes closed by upper connection end 30 of hook 14, thereby capturing end head 38 of screw 40 within seating zone 46—body 12 is now pivotally secured to screw 40. As a final step, the installer simply pull hook portion 28 of hook 14 down away from body 12 and the ceiling about 2 mm to its locking position (as shown in FIGS. 12, 13, 14, and 15), wherein locking tabs 34 of upper connection end 30 engage within locking recesses 35 of body 12 (as shown in FIG. 15). This engagement will prevent hook portion 28 from accidentally pivoting up about pin 16 to the open position (shown in FIGS. 3 through 9) where entryway could become sufficiently open to allow body to slip off of end head 38 of screw 40 and cause the hung load (and the hook assembly 10) to fall from the ceiling. The weight of whatever is being hung on hook 14 will ensure that locking tabs 34 remain firmly in locking engagement with locking recesses 35 and that hook portion 28 remains firmly in the locked position and that hook assembly 10 remains firmly (yet pivotally) secured to ceiling screw 40. Furthermore, the downward force created by the weight of the item being hung by hook 14 will be transferred to (or supported by) the two opposing support sections 32 of upper connection end 30, and in turn transferred to body 12 and then transferred to head-seating surface 48 and finally through end-head 38 of screw 40 and to the ceiling structure. The structure of body 12 and hook 14 is such that the downward forces generated by the hung item never reach pin 16 so that the hook 28 can hold a greater load without failure.

Since screw 40 is centered about the vertical axis 18, hook 14 and body 12 can freely pivot about end head 38. This will allow the hook, and whatever it is holding, to rotate about end head 38 without unscrewing screw 40.

Hook 14 and body 12 are preferably made from an appropriate metal alloy, such as an alloy containing zinc and formed using known die casting techniques. As well known by those skilled in the art, a zinc alloy is preferred because it is easy to cast, is resistant to shock, has a high tensile strength, and low shrinkage and good dimensional tolerances. Moreover, it is easily plateable and, as cast, has a smooth surface that lends itself to plating and post-finishing. A typical useful alloy has zinc as the major component with about 4% of aluminum and about 1% of copper, but of course other alloys may be used without departing from the invention. The die casting parts can be finished by tumbling, sand-blasting, plating and/or polishing, as understood by those skilled in the art.

Also, the body and hook parts can be made from other metals using other methods, such as steel, bronze, brass, and aluminum, and made by known machining and turning methods.

Applicant contemplates making the hook and body parts made from a suitable strong and durable plastic using injection mold techniques. Of course, the parts being made from the different materials will each have their load-limits and will have to be tested and load-rated before sale and use.

Regardless of the materials used for the hook and body parts, pin 16 is preferably made from steel.

What is claimed is:

1. A ceiling hook to be selectively secured to a screw for suspending a load from a ceiling, said screw including a threaded shaft securable to said ceiling, and a head, said hook comprising:
a body having a cavity that is sized and shaped to receive said screw head, said cavity including an open end through which said screw head may selectively pass; and
a hook section that includes an upper end and a lower hook, said hook section being pivotally attached to said body between a hook-down position wherein said hook is accessible to support said load, and a hook-up position, said upper end of said hook section being sized and shaped to block said open end of said cavity when said hook section is in said hook-down position, during which said head becomes captured within said cavity and thereby secured to said body.

2. The ceiling hook, according to claim 1, wherein said body may rotate about said head of said screw, when said screw is captured within said cavity.

3. The ceiling hook, according to claim 1, further including a spring-bias between said body and said hook section to encourage said hook section to rest in said hook-down position so that pivotal movement of said hook section from said hook-down position to said hook-up position must overcome said spring-bias.

4. The ceiling hook, according to claim 3, wherein said spring-bias is generated by an axial spring.

5. The ceiling hook, according to claim 1, wherein said hook section includes structure that locks to said body in response to said load being supported by said hook, during which time said hook section is unable to pivot from said hook-down position.
